(19) United States
(12) Patent Application Publication
(10) Pub. No.: US 2024/0349720 A1
(43) Pub. Date: Oct. 24, 2024

(54) ANTIMICROBIAL COMPOSITIONS COMPRISING ALKYL ETHER CARBOXYLIC ACIDS AND METHODS OF USE THEREOF

(71) Applicant: ECOLAB USA INC., Saint Paul, MN (US)

(72) Inventors: Junzhong Li, Saint Paul, MN (US); Allison Prideaux, Saint Paul, MN (US); Sascha Locher, Monheim (DE); Derrick Anderson, Saint Paul, MN (US); Richard Staub, Saint Paul, MN (US); Jonathan Scott Killeen, Mannheim (DE)

(21) Appl. No.: 18/624,443

(22) Filed: Apr. 2, 2024

Related U.S. Application Data
(60) Provisional application No. 63/497,615, filed on Apr. 21, 2023.

(51) Int. Cl. A01N 37/36; A01N 25/30; A01P 1/00; A01P 3/00

(52) U.S. Cl. CPC A01N 37/36; A01N 25/30; A01P 1/00; A01P 3/00

(57) ABSTRACT

Liquid antimicrobial compositions with yeasticidal and virucidal efficacy including at least one acid, an alkyl ether carboxylic acid, and an additional surfactant, wherein the use pH is less than about 5 are disclosed. The compositions provide effective alternatives to quaternary ammonium compounds while also beneficially providing yeasticidal efficacy in addition to broad antimicrobial and virucidal efficacy. Methods of using the liquid compositions are also disclosed.

### CROSS REFERENCE TO RELATED APPLICATIONS

This application claims priority under 35 U.S.C. § 119 to provisional patent application U.S. Ser. No. 63/497,615, filed Apr. 21, 2023. The provisional patent application is herein incorporated by reference in its entirety.

### TECHNICAL FIELD

The invention relates to antimicrobial compositions including at least one acid, an alkyl ether carboxylic acid, and optionally additional surfactants, wherein the use pH is less than about 5. The compositions provide effective alternatives to quaternary ammonium compounds while also beneficially providing yeasticidal efficacy in addition to broad antimicrobial and virucidal efficacy.

### BACKGROUND

The background description provided herein gives context for the present disclosure. Work of the presently named inventors, as well as aspects of the description that may not otherwise qualify as prior art at the time of filing, are neither expressly nor impliedly admitted as prior art.

Antimicrobial compositions that are effective against a broad spectrum of bacterial and viral pathogens are important to address increasing public health concerns. These pathogens present a significant health concern as they are able to persist on surfaces for long periods of time and require complete and reliable inactivation in order to stop disease transmission. Quaternary ammonium compounds have become a commonplace antimicrobial and are widely used within the foodservice industry for food contact sanitizing and disinfectant applications with disinfection claim sets requiring a follow-up rinse step. However, regulatory changes may limit the use of quaternary ammonium compounds in sanitizing and disinfectant compositions. As a result, replacement compositions with the mandatory yeasticidal activity by European regulations are needed.

In addition to having antimicrobial compositions that are effective against a broad spectrum of bacteria, viral pathogens, and yeast, it is desired for products to maintain a no-rinse capability. This presents challenges due to regulatory requirements for all active and inert ingredients to have a list tolerance designated for chemical substances used as ingredients in antimicrobial pesticide formulations applied to food-contact surfaces, e.g. public eating places, dairy-processing equipment, and food-processing equipment and utensils.

Accordingly, it is an objective of the compositions and methods described herein to provide an antimicrobial product that can offer no-rinse efficacy. In such embodiments a rinse step can be excluded from the methods. Similarly, in such embodiments a wiping step can be further excluded from the methods. It is a further objective of the compositions and methods to provide a product that provides disinfection and yeasticidal efficacy without the use of quaternary ammonium compounds.

A still further object of the compositions and methods is to provide antimicrobial compositions with yeasticidal and virucidal efficacy, including short contact time, preferably 60 minutes or less, more preferably 30 minutes or less, still more preferably 10 minutes or less, and most preferably 5 minutes or less. In some embodiments, the short contact times are achieved with clean conditions. In other embodiments, the short contact times are achieved with dirty or soiled conditions.

Other objects, embodiments and advantages of this disclosure will be apparent to one skilled in the art in view of the following disclosure, the drawings, and the appended claims.

### SUMMARY

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of the present disclosure to improve on or overcome the deficiencies in the art.

According to some aspects of the present disclosure, antimicrobial compositions comprise at least one acid providing a use pH of the composition≤ about 5; a C6-C11 alkyl ether carboxylic acid with a degree of ethoxylation≤6; and optionally an additional surfactant.

According to some additional aspects of the present disclosure, methods of using an antimicrobial composition comprise: contacting the antimicrobial compositions as described herein a surface in need of treatment, and providing at least a 3 log reduction, or at least a 4 log reduction in a yeast population within less than about 5 minutes.

According to some additional aspects of the present disclosure, methods of using an antimicrobial composition comprise: contacting the antimicrobial compositions as described herein a surface in need of treatment, wherein the composition passes one or more of the following European standards at a contact time of less than or equal to about 5 minutes: EN13697, EN1650, EN1276, EN13697, and EN14476.

While multiple embodiments are disclosed, still other embodiments will become apparent to those skilled in the art from the following detailed description, which shows and describes illustrative embodiments. Accordingly, the drawings and detailed description are to be regarded as illustrative in nature and not restrictive.

### DETAILED DESCRIPTION

The present disclosure relates to liquid antimicrobial compositions providing efficacy against microbial and viral pathogens while also providing yeasticidal activity in the form of surface compatible formulations that do not leave hazy, streaky, or tacky residues on treated surfaces.

It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾. This applies regardless of the breadth of the range.

As used herein, the term “and/or”, e.g., “X and/or Y” shall be understood to mean either “X and Y” or “X or Y” and shall be taken to provide explicit support for both meanings or for either meaning, e.g. A and/or B includes the options i) A, ii) B or iii) A and B.

It is to be appreciated that certain features that are, for clarity, described herein in the context of separate embodiments, may also be provided in combination in a single embodiment. Conversely, various features that are, for brevity, described in the context of a single embodiment, may also be provided separately or in any sub-combination.

The methods and compositions of the present disclosure may comprise, consist essentially of, or consist of the components and ingredients of the present disclosure as well as other ingredients described herein. As used herein, “consisting essentially of” means that the compositions and methods may include additional steps, components or ingredients, but only if the additional steps, components or ingredients do not materially alter the basic and novel characteristics of the claimed compositions and methods.

Unless defined otherwise, all technical and scientific terms used above have the same meaning as commonly understood by one of ordinary skill in the art to which embodiments of the present disclosure pertain.

The term “about,” as used herein, refers to variation in the numerical quantity that can occur, for example, through typical measuring techniques and equipment, with respect to any quantifiable variable, including, but not limited to, concentration, mass, volume, time, molecular weight, temperature, pH, humidity, molar ratios, log count of bacteria or viruses, and the like. Further, given solid and liquid handling procedures used in the real world, there is certain inadvertent error and variation that is likely through differences in the manufacture, source, or purity of the ingredients used to make the compositions or carry out the methods and the like. The term “about” also encompasses these variations. Whether or not modified by the term “about,” the claims include equivalents to the quantities.

The term “actives” or “percent actives” or “percent by weight actives” or “actives concentration” are used interchangeably herein and refers to the concentration of those ingredients involved in cleaning expressed as a percentage minus inert ingredients such as water or salts. It is also sometimes indicated by a percentage in parentheses, for example, “chemical (10%).”

As used herein, the term “alkyl” or “alkyl groups” refers to saturated hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups).

Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups.

In some embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan.

Differentiation of antimicrobial “-cidal” or “-static” activity, the definitions which describe the degree of efficacy, and the official laboratory protocols for measuring this efficacy are considerations for understanding the relevance of antimicrobial agents and compositions. Antimicrobial compositions can affect two kinds of microbial cell damage. The first is a lethal, irreversible action resulting in complete microbial cell destruction or incapacitation. The second type of cell damage is reversible, such that if the organism is rendered free of the agent, it can again multiply. The former is termed microbiocidal and the later, microbistatic. A sanitizer and a disinfectant are, by definition, agents which provide antimicrobial or microbiocidal activity. In contrast, a preservative is generally described as an inhibitor or microbistatic composition. As referred to herein, antimicrobial compositions are further suitable for cidal activity against viral pathogens, including for example, Norovirus and Murine Norovirus, including use of EN14476 at 18° C.-25° C. (under clean or dirty conditions).

As used herein, the term “antimicrobial” refers to a compound or composition that reduces and/or inactivates a microbial population, including, but not limited to bacteria, viruses, fungi, and algae within about 10 minutes or less, about 8 minutes or less, about 5 minutes or less, about 3 minutes or less, about 2 minutes or less, about 1 minute or less, or about 30 seconds or less. Preferably, the term antimicrobial refers to a composition that provides at least about a 3-log, 3.5 log, 4 log, 4.5 log, or 5 log reduction of a microbial population in about 10 minutes or less, about 8 minutes or less, about 5 minutes or less, about 3 minutes or less, about 2 minutes or less, about 1 minute or less, or about 30 seconds or less.

As used herein, the term “cleaning” refers to a method used to facilitate or aid in soil removal, bleaching, microbial population reduction, rinsing, and any combination thereof.

The term “commercially acceptable cleaning performance” refers generally to the degree of cleanliness, extent of effort, or both that a typical consumer would expect to achieve or expend when using a cleaning product or cleaning system to address a typical soiling condition on a typical substrate. This degree of cleanliness may, depending on the particular cleaning product and particular substrate, correspond to a general absence of visible soils, or to some lesser degree of cleanliness. Cleanliness may be evaluated in a variety of ways depending on the particular product being used and the particular surface being cleaned, and normally may be determined using generally agreed industry standard tests or localized variations of such tests. In some embodiments, the methods providing virucidal efficacy also provide commercially acceptable cleaning performance while ensuring the formulations do not leave hazy, streaky, or tacky residues on treated surfaces.

As used herein, the term “disinfectant” refers to an agent that kills all vegetative cells including most recognized pathogenic microorganisms. In an embodiment, a disinfectant according to U.S. standards can use the procedure described in A.O.A.C. Use Dilution Methods, Official Methods of Analysis of the Association of Official Analytical Chemists, paragraph 955.14 and applicable sections, 15th Edition, 1990 (EPA Guideline 91-2). As used herein, the term “high level disinfection” or “high level disinfectant” refers to a compound or composition that kills substantially all organisms, except high levels of bacterial spores, and is affected with a chemical germicide cleared for marketing as a sterilant by the Food and Drug Administration. As used herein, the term “intermediate-level disinfection” or “intermediate level disinfectant” refers to a compound or composition that kills mycobacteria, most viruses, and bacteria with a chemical germicide registered as a tuberculocide by the Environmental Protection Agency (EPA). As used herein, the term “low-level disinfection” or “low level disinfectant” refers to a compound or composition that kills some viruses and bacteria with a chemical germicide registered as a hospital disinfectant by the EPA.

In an embodiment, a disinfectant according to EU standards is as set forth in DIRECTIVE 98/8/EC OF THE EUROPEAN PARLIAMENT AND OF THE COUNCIL of 16 Feb. 1998, and Guidance on the Biocidal Products Regulation Volume II Efficacy-Assessment and Evaluation (Parts B+C) Version 3.0 April 2018-ECHA (European Chemicals Agency), each of which are herein incorporated by reference in their entirety.

A disinfectant can include any one of four groups of biocidal products with five defined product types for products that reduces the number of microorganisms in or on an inanimate matrix-achieved by the irreversible action of a product. In an embodiment, the disinfectant products can be confirmed using a variety of recognized testing methods (CEN, OECD, ISO, etc.); see Guidance document Appendices 2 and 4. According to various embodiments of the methods and compositions described herein, the EN1276 methodology was used to demonstrate bactericidal performance with a 5 log reduction requirement and the EN14476 methodology was used to demonstrate viricidal performance with a 4 log reduction requirement.

As used herein, the term “exemplary” refers to an example, an instance, or an illustration, and does not indicate a most preferred embodiment unless otherwise stated.

As used herein, the phrase “food processing surface” refers to a surface of a tool, a machine, equipment, a structure, a building, or the like that is employed as part of a food processing, preparation, or storage activity. Examples of food processing surfaces include surfaces of food processing or preparation equipment (e.g., slicing, canning, or transport equipment, including flumes), of food processing wares (e.g., utensils, dishware, wash ware, and bar glasses), and of floors, walls, or fixtures of structures in which food processing occurs. Food processing surfaces are found and employed in food anti-spoilage air circulation systems, aseptic packaging sanitizing, food refrigeration and cooler cleaners and sanitizers, ware washing sanitizing, blancher cleaning and sanitizing, food packaging materials, cutting board additives, third-sink sanitizing, beverage chillers and warmers, meat chilling or scalding waters, autodish sanitizers, sanitizing gels, cooling towers, food processing antimicrobial garment sprays, and non-to-low-aqueous food preparation lubricants, oils, and rinse additives.

As used herein, the term “free” refers to compositions completely lacking the component or having such a small amount of the component that the component does not affect the performance of the composition.

The term “generally” encompasses both “about” and “substantially.”

The term “hard surface” refers to a solid, substantially non-flexible surface such as a counter top, tile, floor, wall, panel, window, plumbing fixture, kitchen and bathroom furniture, appliance, engine, circuit board, dish, mirror, window, monitor, touch screen, and thermostat. Hard surfaces are not limited by the material; for example, a hard surface can be glass, metal, tile, vinyl, linoleum, composite, wood, plastic, etc. Hard surfaces may include for example, health care surfaces and food processing surfaces.

As used herein, the phrase “health care surface” refers to a surface of an instrument, a device, a cart, a cage, furniture, a structure, a building, or the like that is employed as part of a health care activity. Examples of health care surfaces include surfaces of medical or dental instruments, of medical or dental devices, of electronic apparatus employed for monitoring patient health, and of floors, walls, or fixtures of structures in which health care occurs. Health care surfaces are found in hospital, surgical, infirmity, birthing, mortuary, and clinical diagnosis rooms. These surfaces can be those typified as “hard surfaces” (such as walls, floors, bed-pans, etc.), or fabric surfaces, e.g., knit, woven, and non-woven surfaces (such as surgical garments, draperies, bed linens, bandages, etc.), or patient-care equipment (such as respirators, diagnostic equipment, shunts, body scopes, wheel chairs, beds, etc.), or surgical and diagnostic equipment. Health care surfaces include articles and surfaces employed in animal health care.

As used herein, the term “instrument” refers to the various medical or dental instruments or devices that can benefit from cleaning with a composition as described herein.

As used herein, the term “microorganism” refers to any noncellular or unicellular (including colonial) organism. Microorganisms include all prokaryotes. Microorganisms include bacteria (including cyanobacteria), spores, lichens, fungi, protozoa, virinos, viroids, viruses, phages, and some algae. As used herein, the term “microbe” is synonymous with microorganism.

The term “norovirus” is meant to refer to the human norovirus (referred to simply as norovirus) which is in the family Caliciviridae, which is the leading cause of acute nonbacterial gastroenteritis. There are various surrogates commonly used for norovirus as to date, human norovirus cannot be grown in cell culture. Norovirus has a low infectious dose (10 to 100 virus particles) and environmental contamination prolongs outbreaks. Surfaces, serving dishes or containers, utensils, and food handled by ill persons who are not practicing adequate personal hygiene before preparing food may also contribute to illness. Feline calicivirus (FCV), from the genus Vesivirus, can be propagated in cell culture, it has been extensively studied as a surrogate for human norovirus in environmental survival and inactivation studies. However, FCV is transmitted by the respiratory route and is inactivated at a relatively low pH, and hence, it may not predict human norovirus environmental stability or inactivation. Mouse norovirus 1 (MNV-1) has been propagated in cell culture and causes a lethal infection in mice that presents as hepatitis, pneumonia, or inflammation of the nervous system and is therefore very different from the clinical presentation of the human norovirus; however, MNV-1 is shed in mouse feces and is commonly transmitted by the fecal-oral route. The genetic relatedness of MNV-1 to norovirus combined with its ability to survive under gastric pH levels (minimal loss of infectivity at pH 2) makes this virus a relevant surrogate for studying environmental survival of norovirus. The MNV-1 is able to survive low pH and is superior in acid tolerance in comparison to FCV.

As used herein the term “polymer” refers to a molecular complex comprised of a more than ten monomeric units and generally includes, but is not limited to, homopolymers, copolymers, such as for example, block, graft, random and alternating copolymers, terpolymers, and higher “x” mers, further including their analogs, derivatives, combinations, and blends thereof. Furthermore, unless otherwise specifically limited, the term “polymer” shall include all possible isomeric configurations of the molecule, including, but are not limited to isotactic, syndiotactic and random symmetries, and combinations thereof. Furthermore, unless otherwise specifically limited, the term “polymer” shall include all possible geometrical configurations of the molecule.

As used herein, the term “sanitizer” refers to an agent that reduces the number of bacterial contaminants to safe levels as judged by public health requirements. In an embodiment, sanitizers for use in this invention will provide at least a 99.999% reduction (5-log order reduction). These reductions can be evaluated using a procedure set out in Germicidal and Detergent Sanitizing Action of Disinfectants, Official Methods of Analysis of the Association of Official Analytical Chemists, paragraph 960.09 and applicable sections, 15th Edition, 1990 (EPA Guideline 91-2). According to this reference a sanitizer should provide a 99.999% reduction (5-log order reduction) within 30 seconds at room temperature, 25±2° C., against several test organisms.

As used herein, the term “soil” or “stain” refers to any soil, including, but not limited to, non-polar oily and/or hydrophobic substances which may or may not contain particulate matter such as industrial soils, mineral clays, sand, natural mineral matter, carbon black, graphite, kaolin, environmental dust, and/or food based soils such as blood, proteinaceous soils, starchy soils, fatty soils, cellulosic soils, etc.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

The term “substantially” refers to a great or significant extent. “Substantially” can thus refer to a plurality, majority, and/or a supermajority of said quantifiable variable, given proper context.

As used herein, the term “substantially free” refers to compositions completely lacking the component or having such a small amount of the component that the component does not affect the performance of the composition. The component may be present as an impurity or as a contaminant and shall be less than 0.5 wt-%. In another embodiment, the amount of the component is less than 0.1 wt-% and in yet another embodiment, the amount of component is less than 0.01 wt-%.

The term “surfactant” or “surface active agent” refers to an organic chemical that when added to a liquid changes the properties of that liquid at a surface.

As used herein, the term “virucidal” refers to an agent that reduces the number of viruses on a surface or substrate. In an embodiment, virucidal compositions will provide at least a 3-log order reduction, or preferably a 5-log order reduction, or more preferably a complete inactivation of viruses. These reductions can be evaluated using a procedure set out in ASTM E1053 Standard Test Method for Efficacy of Virucidal Agents Intended for Inanimate Environmental Surfaces; US standards are set forth in EPA 810.2200; EP standards are set forth in EN 14476, each of which are herein incorporated by reference in its entirety. The outlined log reductions can be achieved over various periods of time (which can vary according to contact time requirements set forth in various jurisdictions), including for example less than about 60 minutes, less than about 30 minutes, less than about 5 minutes, less than 1 minute, less than about 30 seconds, or even less than about 15 seconds. According to this reference a virucidal composition should provide a 99.9% reduction (3-log order reduction) for virucidal activity.

The term “virus”, as used herein refers to a type of microorganism that can include both pathogenic and non-pathogenic viruses. Pathogenic viruses can be classified into two general types with respect to the viral structure: enveloped viruses and non-enveloped viruses. Some well-known enveloped viruses include herpes virus, influenza virus; paramyxovirus, respiratory syncytial virus, corona virus, HIV, hepatitis B virus, hepatitis C virus and SARS-COV virus. Non-enveloped viruses, sometimes referred to as “naked” viruses, include the families Picornaviridae, Reoviridae, Caliciviridae, Adenoviridae and Parvoviridae. Members of these families include rhinovirus, poliovirus, adenovirus, hepatitis A virus, norovirus, papillomavirus, and rotavirus. It is known in the art that “enveloped” viruses are relatively sensitive and, thus, can be inactivated by commonly used disinfectants. In contrast, non-enveloped viruses are substantially more resistant to conventional disinfectants and are significantly more environmentally stable than enveloped viruses.

As used herein, the term “waters” includes various water sources. Water temperatures can range from about 40° F.-160° F., about 60° F.-140° F., or about 70° F.-140° F.

The term “water soluble” refers to a compound that can be dissolved in water at a concentration of more than 1 wt. %. The terms “sparingly soluble” or “sparingly water soluble” refer to a compound that can be dissolved in water only to a concentration of 0.1 to 1.0 wt. %. The term “water insoluble” refers to a compound that can be dissolved in water only to a concentration of less than 0.1 wt. %.

The term “weight percent,” wt-%, “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

The term “yeasticidal” refers to the ability of a composition to destroy yeast, a type of fungus, including both vegetative and spore forms of yeast. In an embodiment, yeasticidal compositions will provide at least a 3-log order reduction, or a 4-log order reduction of yeast. These reductions can be evaluated using a procedure set out in EP standards EN 13697 (requiring a 3-log order reduction) and EN1650 (requiring a 4-log order reduction), each of which are herein incorporated by reference in its entirety. The outlined log reductions can be achieved over various periods of time (which can vary according to contact time requirements set forth in various jurisdictions), including for example less than about 60 minutes, less than about 30 minutes, less than about 10 minutes, or less than about 5 minutes. According to this reference a yeasticidal composition should provide at least a 99.9% reduction (3-log order reduction) for virucidal activity when tested using EN13697 and at least a 99.99% reduction when tested using EN1650.

### Antimicrobial Compositions

Exemplary ranges of the antimicrobial compositions with yeasticidal and virucidal efficacy are shown in Tables 1A and 1B showing liquid concentrate formulations on a weight percentage basis. While the components may have a percent actives of 100%, it is noted that Tables 1A and 1B do not recite the percent actives of the components, but rather, recites the total weight percentage of the raw materials (i.e. active concentration plus inert ingredients).

TABLE 1A

| | First | Second | Third |
|---|---|---|---|
| | Exemplary | Exemplary | Exemplary |
| Material | Range wt.-% | Range wt.-% | Range wt.-% |
| Acid source(s) | 1-60 | 10-60 | 10-50 |
| Alkyl Ether Carboxylic | 5-60 | 10-50 | 20-40 |
| Acid | | | |
| Additional Surfactant(s) | 0-20 | 0-15 | 0-10 |
| Additional Functional | 0-40 | 0-30 | 0-20 |
| Ingredients | | | |
| Water | Remainder | Remainder | Remainder |
| Total | 100 | 100 | 100 |

TABLE 1B

| | First | Second | Third |
|---|---|---|---|
| | Exemplary | Exemplary | Exemplary |
| Material | Range wt.-% | Range wt.-% | Range wt.-% |
| Weak Acid source(s) | 1-40 | 10-40 | 20-35 |
| Strong Acid source(s) | 1-20 | 5-20 | 5-15 |
| Alkyl Ether Carboxylic | 5-60 | 10-50 | 20-40 |
| Acid | | | |
| Additional surfactant(s) | 1-20 | 1-10 | 2-10 |
| Additional Functional | 0-40 | 0-30 | 0-20 |
| Ingredients | | | |
| Water | Remainder | Remainder | Remainder |
| Total | 100 | 100 | 100 |

The antimicrobial compositions may include concentrate compositions which can be diluted to form use compositions or ready to use (RTU) compositions. Beneficially, the compositions overcome a limitation of the prior art in that dilutable concentrates can be provided. In general, a concentrate refers to a composition that is intended to be diluted with water to provide a use solution that contacts an object to provide the desired cleaning, antimicrobial efficacy, or the like. The antimicrobial compositions that contacts the articles can be referred to as a concentrate or a use composition (or use solution) dependent upon the formulation employed in the methods described herein. It should be understood that the concentration of the components in the composition will vary depending on whether the composition is provided as a concentrate or as a use solution. One skilled in the art can adjust % by weight of the compositions to arrive at a composition having a different dilution rate, which is within the scope of the disclosed compositions. Beneficially, within the ranges of actives, the compositions can be formulated to include a nearly or completely waterless liquid or solid composition.

A use solution may be prepared from the concentrate by diluting the liquid concentrate with water at a dilution ratio that provides a use solution having desired antimicrobial properties. The water that is used to dilute the concentrate to form the use composition can be referred to as water of dilution or a diluent, and can vary from one location to another. The typical dilution factor is between approximately 1 and approximately 10,000. In an embodiment, the liquid concentrate is diluted at a ratio of between about 1:10 and about 1:10,000 liquid concentrate to water, between about 1:10 and about 1:1,000 liquid concentrate to water, or between about 1:10 and about 1:510 liquid concentrate to water.

In an embodiment, a diluted use solution is made from about a 0.25% to about a 5% by weight dilution of the liquid concentrate composition. In another embodiment, a concentrate can be diluted at a concentration from about 0.25% to about 2.0%, from about 0.50% to about 1.5%, or from about 0.5% to about 1.0% while providing sanitizing efficacy.

In another embodiment, a concentrate can be diluted at a concentration from about 0.25% to about 5.0%, from about 0.5% to about 5.0%, or from about 1.0% to about 5.0% while providing disinfecting efficacy.

The liquid compositions can be provided in various forms well appreciated by those skilled in the art. The compositions can also be manufactured to include a saturated antimicrobial wipe, such as a paper or cloth substrate having the liquid compositions saturated thereon. In embodiments, the liquid compositions are provided as liquid concentrates. In other embodiments, the liquid compositions are provided as ready to use liquids, such as for example a ready to use spray. Such embodiments may further include additional functional ingredients, including for example solvent(s), defoamers, or the like. The addition of such components provide a desired viscoelasticity of the composition to allow for spraying, pumping, or desired dispensing. In some embodiments, it may be desired for dispensing a ready to use application that has foaming suitable for applying to vertical surfaces. Such foaming applications can include formulations that are ready to use (e.g. foaming triggers for dispensing) or dilutable concentrates.

### Acid Sources

The antimicrobial compositions comprise at least one acid providing a use solution pH of the composition less than or equal to about 5. Without being limited to a particular mechanism of action or theory of the invention, the combination of at least one acid, strong and/or weak acids, providing a use solution pH≤5 with the described alkyl ether carboxylic acids provide efficacious activity at pH up to about 5 due to the carboxylic acid structure in the alkyl ether carboxylic acid. In some embodiments, at least one acid, or at least two acids are included in the composition provide the use solution pH≤5.

In embodiments, the compositions include from about 1 wt-% to about 60 wt-% of a weak acid, from about 10 wt-% to about 60 wt-% of at least one acid, from about 10 wt-% to about 50 wt-% of at least one acid, from about 20 wt-% to about 50 wt-% of at least one acid, or from about 20 wt-% to about 40 wt-% of at least one acid. In addition, without being limited according to the invention, all ranges recited are inclusive of the numbers defining the range and include each integer within the defined range.

### Weak Acids

In embodiments, the antimicrobial compositions comprise at least one weak acid providing a use solution pH of the composition less than or equal to about 5. For the purposes of this invention, an acid is a component that can be added to an aqueous system and result in a pH less than 7. “Weak” organic and inorganic acids are acids or acid components in which the first dissociation step of a proton from the acid moiety does not proceed essentially to completion when the acid is dissolved in water at ambient temperatures at a concentration within the range useful to form the present compositions. Without wishing to be bound by theory, the acids disclosed herein facilitate the creation of a low pH buffer on the surface of a substrate, thereby prolonging the residual antimicrobial including yeasticidal and virucidal activity of the compositions and products in which they are incorporated.

Exemplary weak acids suitable for use in the compositions include alpha hydroxycarboxylic acids, such as lactic acid, glycolic acid, citric acid, tartaric acid, malic acid, gluconic acid, and the like; alkyl carboxylic acids, such as formic acid, acetic acid, propionic acid, and the like; other common organic acids such as ascorbic acid, glutamic acid, levulinic acid, etc.

In a preferred embodiment, the compositions include a weak acid having a pKa greater than about 2.5 to beneficially provide the acidic use compositions having a pH less than about 6, less than about 5, less than about 4, or preferably less than about 3.

In an embodiment, the compositions include formic acid. In embodiments, a combination of a strong acid with a weak acid provide increased antimicrobial and virucidal efficiency. In a preferred embodiment, the acids comprise formic acid and methane sulfonic acid. Without being limited to a particular mechanism of action, it may be desirable to have a buffered acidic composition. For example, if a surface in need of treatment is not sufficiently cleaned the compositions have a buffered composition by virtue of a combination of weak and strong acids will beneficially be able to support inactivation of pH sensitive organisms.

In embodiments, the compositions include from about 1 wt-% to about 40 wt-% of a weak acid, from about 10 wt-% to about 40 wt-% of a weak acid, from about 15 wt-% to about 40 wt-% of a weak acid, from about 20 wt-% to about 40 wt-% of a weak acid, or from about 20 wt-% to about 35 wt-% of a weak acid. In addition, without being limited according to the invention, all ranges recited are inclusive of the numbers defining the range and include each integer within the defined range.

### Strong Acids

In embodiments, the antimicrobial compositions comprise at least one strong acid providing a use solution pH of the composition less than or equal to about 5. Strong acids that can be used are acids which substantially dissociate an aqueous solution.

Exemplary strong acids suitable for use in the compositions include methane sulfonic acid, sulfuric acid, sodium hydrogen sulfate, phosphoric acid, phosphonic acid, nitric acid, sulfamic acid, hydrochloric acid, trichloroacetic acid, trifluoroacetic acid, toluene sulfonic acid, glutamic acid, and the like; alkane sulfonic acid, such as methane sulfonic acid, ethane sulfonic acid, linear alkyl benzene sulfonic acid, xylene sulfonic acid, cumene sulfonic acid and the like.

In a preferred embodiment, the compositions include a strong acid having a pKa less than about 2.5 to beneficially provide the acidic use compositions having a pH less than about 5, less than about 4, or less than about 3. In a preferred embodiment, the strong acid is methane sulfonic acid.

In certain embodiments, the compositions include from about 0.1 wt-% to about 20 wt-% of a strong acid, from about 1 wt-% to about 20 wt-% of a strong acid, from about 5 wt-% to about 20 wt-% of a strong acid, or from about 5 wt-% to about 15 wt-% of a strong acid. In addition, without being limited according to the invention, all ranges recited are inclusive of the numbers defining the range and include each integer within the defined range.

### Alkyl Ether Carboxylic Acid

In embodiments, the antimicrobial compositions comprise an alkyl ether carboxylic acid. Alkyl ether carboxylic acids have the following formula: R—(CH₂CH₂O)ₙ—CH₂COOH, wherein R is a C₆ to C₁₁ alkyl group, and n (referring to degree of ethoxylation) is an integer of 1-6, or preferably n is an integer of 4-6. In some embodiments, R is a C₆-C₁₀ alkyl group, n is an integer of 4-5. Exemplary alkyl ether carboxylic acids include capryleth-4-carboxlyic acid (where R is C8 alkyl group and n is 4) and capryleth-6-carboxlyic acid (where R is C8 alkyl group and n is 5).

In an aspect, the compositions include from about 1 wt-% to about 40 wt-%, from about 5 wt-% to about 40 wt-%, from about 10 wt-% to about 40 wt-%, from about 15 wt-% to about 40 wt-%, or from about 20 wt-% to about 40 wt-% of the alkyl ether carboxylic acid surfactants. In addition, without being limited according to the invention, all ranges recited are inclusive of the numbers defining the range and include each integer within the defined range.

### Additional Surfactant(s)

In embodiments, the antimicrobial compositions comprise at least one additional surfactant in combination with the alkyl ether carboxylic acid. The additional surfactant can comprise an anionic surfactant, nonionic surfactant, amphoteric surfactant, zwitterionic surfactant, or combinations thereof as the alkyl ether carboxylic acid surfactants are beneficially compatible with the various classes of surfactants.

In an embodiment, the compositions include from about 1 wt-% to about 40 wt-%, from about 1 wt-% to about 30 wt-%, from about 2 wt-% to about 30 wt-%, from about 2 wt-% to about 20 wt-%, or from about 2 wt-% to about 10 wt-% of the additional surfactant(s). In addition, without being limited according to the invention, all ranges recited are inclusive of the numbers defining the range and include each integer within the defined range.

### Anionic Surfactants

Anionic surfactants are surface active substances which are categorized by the negative charge on the hydrophobe; or surfactants in which the hydrophobic section of the molecule carries no charge unless the pH is elevated to neutrality or above (e.g. carboxylic acids). Carboxylate, sulfonate, sulfate and phosphate are the polar (hydrophilic) solubilizing groups found in anionic surfactants. Of the cations (counter ions) associated with these polar groups, sodium, lithium and potassium impart water solubility; ammonium and substituted ammonium ions provide both water and oil solubility; and calcium, barium, and magnesium promote oil solubility.

Exemplary anionic surfactants include for example: sulfonates, including alkyl sulfonates, aromatic sulfonates with or without substituents, alcohol ether carboxylates and sulfonated carboxylic acid esters, sulfates, carboxylates, ethoxy carboxylates, and phosphate esters.

In an embodiment, the additional anionic surfactant comprises an alpha olefin sulfonate, alkane sulfonate, alkyl sulfonate, sulfonated carboxylic acid ester, alkyl polyglucoside, phosphate ester or combination thereof.

In an embodiment, an anionic sulfonate surfactant is an alkyl sulfonate, including linear and branched primary and secondary alkyl sulfonates, and the aromatic sulfonates with or without substituents. In a preferred embodiment the anionic sulfonate surfactant is an alpha olefin sulfonate or its salts. Alpha olefin sulfonates are available as aqueous solutions, powders or as a solid anhydrous product. Preferred anionic sulfonates include C8-C22 alpha olefin sulfonates, or C8-C16 alpha olefin sulfonates. Beneficially, alpha olefin sulfonate surfactants are stable in hard water. They are clear stable solutions which is particularly appealing for customer use.

In an embodiment, an anionic surfactant is sulfonates, such as a sulfonated carboxylic acid ester. In an aspect, suitable alkyl sulfonate surfactants include C8-C22 alkyl sulfonates, or preferably C8-C16 alkyl sulfonates or C10-C22 alkyl sulfonates. In an exemplary aspect, the anionic alkyl sulfonate surfactant is linear alkyl benzene sulfonic acid (LAS). The inclusion of additional anionic alkyl sulfonates may vary based on regulatory applicability for virucidal, sanitizing and/or disinfecting applications.

Anionic sulfate surfactants include alkyl ether sulfates, alkyl sulfates, the linear and branched primary and secondary alkyl sulfates, alkyl ethoxysulfates, fatty oleyl glycerol sulfates, alkyl phenol ethylene oxide ether sulfates, the C₅-C₁₇ acyl-N—(C₁-C₄ alkyl) and —N—(C₁-C₂ hydroxyalkyl) glucamine sulfates, and sulfates of alkylpolysaccharides such as the sulfates of alkylpolyglucoside, and the like. Also included are the alkyl sulfates, alkyl poly(ethyleneoxy) ether sulfates and aromatic poly(ethyleneoxy) sulfates such as the sulfates or condensation products of ethylene oxide and nonyl phenol (usually having 1 to 6 oxyethylene groups per molecule).

Additional anionic surfactants include anionic carboxylate surfactants, those which have a carboxylic acid or an alpha hydroxyl acid group. Anionic carboxylate surfactants suitable for use in the compositions also include carboxylic acids (and salts), such as alkanoic acids (and alkanoates), ester carboxylic acids (including sulfonated carboxylic acid esters), ether carboxylic acids, sulfonated fatty acids, such as sulfonated oleic acid, and the like. In an aspect, suitable ester carboxylic acids include alkyl succinates, such as for example dioctyl sulfosuccinate. Such carboxylates include alkyl ethoxy carboxylates, alkyl aryl ethoxy carboxylates, alkyl polyethoxy polycarboxylate surfactants and soaps (e.g. alkyl carboxyls).

Secondary carboxylates include those which contain a carboxyl unit connected to a secondary carbon. The secondary carbon can be in a ring structure, e.g. as in p-octyl benzoic acid, or as in alkyl-substituted cyclohexyl carboxylates. The secondary carboxylate surfactants typically contain no ether linkages, no ester linkages and no hydroxyl groups. Further, they typically lack nitrogen atoms in the head-group (amphiphilic portion). Suitable secondary surfactants typically contain 11-13 total carbon atoms, although more carbons atoms (e.g., up to 16) can be present. Suitable carboxylates also include acylamino acids (and salts), such as acylgluamates, acyl peptides, sarcosinates (e.g. N-acyl sarcosinates), taurates (e.g. N-acyl taurates and fatty acid amides of methyl tauride), and the like.

In an embodiment, the compositions include from about 1 wt-% to about 20 wt-%, from about 2 wt-% to about 20 wt-%, or from about 2 wt-% to about 10 wt-% of the additional anionic surfactant(s). In addition, without being limited according to the invention, all ranges recited are inclusive of the numbers defining the range and include each integer within the defined range.

### Nonionic Surfactants

Suitable nonionic surfactants suitable for use with the compositions include alkoxylated surfactants. Suitable alkoxylated surfactants include EO/PO copolymers, capped EO/PO copolymers, alcohol alkoxylates, capped alcohol alkoxylates, mixtures thereof, or the like. Suitable alkoxylated surfactants for use as solvents include EO/PO block copolymers, such as the Pluronic and reverse Pluronic surfactants; alcohol alkoxylates, such as Dehypon LS-54 (R-(EO)₅(PO)₄) and Dehypon LS-36 (R-(EO)₃(PO)₆); and capped alcohol alkoxylates, such as Plurafac LF221 and Tegoten EC11; mixtures thereof, or the like.

In an exemplary aspect, a nonionic surfactant available on the market under the trade name of “Pluronic” is included as an additional surfactant in the compositions. These compounds are formed by condensing ethylene oxide with a hydrophobic base formed by the condensation of propylene oxide with propylene glycol. The hydrophobic portion of the molecule has a molecular weight of from about 1,500 to 1,800. The addition of polyoxyethylene radicals to this hydrophobic portion tends to increase the water solubility of the molecule as a whole and the liquid character of the products is retained up to the point where the polyoxyethylene content is about 50 percent of the total weight of the condensation product.

The semi-polar type of nonionic surface active agents is another class of nonionic surfactant useful in compositions. Semi-polar nonionic surfactants include the amine oxides, phosphine oxides, sulfoxides and their alkoxylated derivatives.

Amine oxides are tertiary amine oxides corresponding to the general formula:

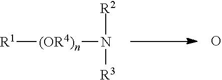

wherein the arrow is a conventional representation of a semi-polar bond; and R¹, R², and R³ may be aliphatic, aromatic, heterocyclic, alicyclic, or combinations thereof. Generally, for amine oxides of detergent interest, R¹ is an alkyl radical of from about 8 to about 24 carbon atoms; R² and R³ are alkyl or hydroxyalkyl of 1-3 carbon atoms or a mixture thereof; R² and R³ can be attached to each other, e.g. through an oxygen or nitrogen atom, to form a ring structure; R⁴ is an alkylene or a hydroxyalkylene group containing 2 to 3 carbon atoms; and n ranges from 0 to about 20. An amine oxide can be generated from the corresponding amine and an oxidizing agent, such as hydrogen peroxide.

Useful water soluble amine oxide surfactants are selected from the octyl, decyl, dodecyl, isododecyl, coconut, or tallow alkyl di-(lower alkyl) amine oxides, specific examples of which are octyldimethylamine oxide, nonyldimethylamine oxide, decyldimethylamine oxide, undecyldimethylamine oxide, dodecyldimethylamine oxide, iso-dodecyldimethyl amine oxide, tridecyldimethylamine oxide, tetradecyldimethylamine oxide, pentadecyldimethylamine oxide, hexadecyldimethylamine oxide, heptadecyldimethylamine oxide, octadecyldimethylaine oxide, dodecyldipropylamine oxide, tetradecyldipropylamine oxide, hexadecyldipropylamine oxide, tetradecyldibutylamine oxide, octadecyldibutylamine oxide, bis(2-hydroxyethyl) dodecylamine oxide, bis(2-hydroxyethyl)-3-dodecoxy-1-hydroxypropylamine oxide, dimethyl-(2-hydroxydodecyl) amine oxide, 3,6,9-trioctadecyldimethylamine oxide and 3-dodecoxy-2-hydroxypropyldi-(2-hydroxyethyl) amine oxide.

In an embodiment, the compositions include from about 1 wt-% to about 20 wt-%, from about 2 wt-% to about 20 wt-%, or from about 2 wt-% to about 10 wt-% of the additional nonionic surfactant(s). In addition, without being limited according to the invention, all ranges recited are inclusive of the numbers defining the range and include each integer within the defined range.

### Amphoteric Surfactants

Suitable amphoteric surfactants suitable for use with the compositions include surfactants with both a basic and an acidic hydrophilic group and an organic hydrophobic group. These ionic entities may be any of anionic or cationic groups described herein for other types of surfactants. A basic nitrogen and an acidic carboxylate group are the typical functional groups employed as the basic and acidic hydrophilic groups. In a few surfactants, sulfonate, sulfate, phosphonate or phosphate provide the negative charge.

Amphoteric surfactants can be broadly described as derivatives of aliphatic secondary and tertiary amines, in which the aliphatic radical may be straight chain or branched and wherein one of the aliphatic substituents contains from about 8 to 18 carbon atoms and one contains an anionic water solubilizing group, e.g., carboxy, sulfo, sulfato, phosphato, or phosphono. Amphoteric surfactants are subdivided into two major classes known to those of skill in the art and described in “Surfactant Encyclopedia” Cosmetics & Toiletries, Vol. 104 (2) 69-71 (1989), which is herein incorporated by reference in its entirety. The first class includes acyl/dialkyl ethylenediamine derivatives (e.g. 2-alkyl hydroxyethyl imidazoline derivatives) and their salts. The second class includes N-alkylamino acids and their salts. Some amphoteric surfactants can be envisioned as fitting into both classes.

Amphoteric surfactants can be synthesized by methods known to those of skill in the art. For example, 2-alkyl hydroxyethyl imidazoline is synthesized by condensation and ring closure of a long chain carboxylic acid (or a derivative) with dialkyl ethylenediamine. Commercial amphoteric surfactants are derivatized by subsequent hydrolysis and ring-opening of the imidazoline ring by alkylation—for example with chloroacetic acid or ethyl acetate. During alkylation, one or two carboxy-alkyl groups react to form a tertiary amine and an ether linkage with differing alkylating agents yielding different tertiary amines.

Long chain imidazole derivatives having application in the present invention generally have the general formula:

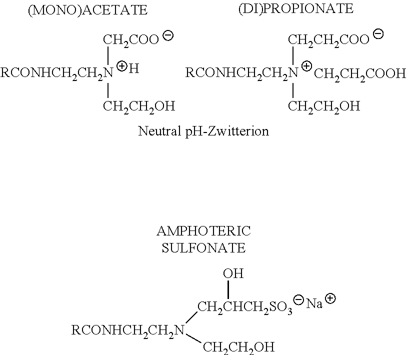

wherein R is an acyclic hydrophobic group containing from about 8 to 18 carbon atoms and M is a cation to neutralize the charge of the anion, generally sodium. Commercially prominent imidazoline-derived amphoterics that can be employed in the present compositions include for example: Cocoamphopropionate, Cocoamphocarboxy-propionate, Cocoamphoglycinate, Cocoamphocarboxy-glycinate, Cocoamphopropyl-sulfonate, and Cocoamphocarboxy-propionic acid. Amphocarboxylic acids can be produced from fatty imidazolines in which the dicarboxylic acid functionality of the amphodicarboxylic acid is diacetic acid and/or dipropionic acid.

The carboxymethylated compounds (glycinates) described herein above frequently are called betaines. Betaines are a special class of amphoteric discussed herein below in the section entitled, Zwitterion Surfactants.

Long chain N-alkylamino acids are readily prepared by reaction RNH₂, in which R=C₈-C₁₈ straight or branched chain alkyl, fatty amines with halogenated carboxylic acids. Alkylation of the primary amino groups of an amino acid leads to secondary and tertiary amines. Alkyl substituents may have additional amino groups that provide more than one reactive nitrogen center. Most commercial N-alkylamine acids are alkyl derivatives of beta-alanine or beta-N(2-carboxyethyl) alanine. Examples of commercial N-alkylamino acid ampholytes having application in this invention include alkyl beta-amino dipropionates, RN(C₂H₄COOM)₂ and RNHC₂H₄COOM. In an embodiment, R can be an acyclic hydrophobic group containing from about 8 to about 18 carbon atoms, and M is a cation to neutralize the charge of the anion.

Suitable amphoteric surfactants include those derived from coconut products such as coconut oil or coconut fatty acid. Additional suitable coconut derived surfactants include as part of their structure an ethylenediamine moiety, an alkanolamide moiety, an amino acid moiety, e.g., glycine, or a combination thereof; and an aliphatic substituent of from about 8 to 18 (e.g., 12) carbon atoms. Such a surfactant can also be considered an alkyl amphodicarboxylic acid. These amphoteric surfactants can include chemical structures represented as: C₁₂-alkyl-C(O)—NH—CH₂—CH₂—N⁺(CH₂—CH₂—CO₂Na)₂—CH₂—CH₂—OH or C₁₂-alkyl-C(O)—N(H)—CH₂—CH₂—N⁺(CH₂—CO₂Na)₂—CH₂—CH₂—OH. Disodium cocoampho dipropionate is one suitable amphoteric surfactant and is commercially available under the tradename Miranol™ FBS from Rhodia Inc., Cranbury, N.J. Another suitable coconut derived amphoteric surfactant with the chemical name disodium cocoampho diacetate is sold under the tradename Mirataine™ JCHA, also from Rhodia Inc., Cranbury, N.J.

A typical listing of amphoteric classes, and species of these surfactants, is given in U.S. Pat. No. 3,929,678 issued to Laughlin and Heuring on Dec. 30, 1975. Further examples are given in “Surface Active Agents and Detergents” (Vol. I and II by Schwartz, Perry and Berch).

In an embodiment, the compositions include from about 1 wt-% to about 20 wt-%, from about 2 wt-% to about 20 wt-%, or from about 2 wt-% to about 10 wt-% of the additional amphoteric surfactant(s). In addition, without being limited according to the invention, all ranges recited are inclusive of the numbers defining the range and include each integer within the defined range.

### Zwitterionic Surfactants

Suitable zwitterionic surfactants suitable for use with the compositions include derivatives of secondary and tertiary amines, derivatives of heterocyclic secondary and tertiary amines, or derivatives of quaternary ammonium, quaternary phosphonium or tertiary sulfonium compounds. Typically, a zwitterionic surfactant includes a positive charged quaternary ammonium or, in some cases, a sulfonium or phosphonium ion; a negative charged carboxyl group; and an alkyl group. Zwitterionics generally contain cationic and anionic groups which ionize to a nearly equal degree in the isoelectric region of the molecule and which can develop strong “inner-salt” attraction between positive-negative charge centers. Examples of such zwitterionic synthetic surfactants include derivatives of aliphatic quaternary ammonium, phosphonium, and sulfonium compounds, in which the aliphatic radicals can be straight chain or branched, and wherein one of the aliphatic substituents contains from 8 to 18 carbon atoms and one contains an anionic water solubilizing group, e.g., carboxy, sulfonate, sulfate, phosphate, or phosphonate.

Betaine and sultaine surfactants are exemplary zwitterionic surfactants for use herein. A general formula for these compounds is:

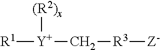

wherein R¹ contains an alkyl, alkenyl, or hydroxyalkyl radical of from 8 to 18 carbon atoms having from 0 to 10 ethylene oxide moieties and from 0 to 1 glyceryl moiety; Y is selected from the group consisting of nitrogen, phosphorus, and sulfur atoms; R² is an alkyl or monohydroxy alkyl group containing 1 to 3 carbon atoms; x is 1 when Y is a sulfur atom and 2 when Y is a nitrogen or phosphorus atom, R³ is an alkylene or hydroxy alkylene or hydroxy alkylene of from 1 to 4 carbon atoms and Z is a radical selected from the group consisting of carboxylate, sulfonate, sulfate, phosphonate, and phosphate groups.

Examples of zwitterionic surfactants having the structures listed above include: 4-[N,N-di(2-hydroxyethyl)-N-octadecylammonio]-butane-1-carboxylate; 5-[S-3-hydroxypropyl-S-hexadecylsulfonio]-3-hydroxypentane-1-sulfate; 3-[P,P-dicthyl-P-3,6,9-trioxatetracosanephosphonio]-2-hydroxypropane-1-phosphate; 3-[N,N-dipropyl-N-3-dodecoxy-2-hydroxypropyl-ammonio]-propane-1-phosphonate; 3-(N,N-dimethyl-N-hexadecylammonio)-propane-1-sulfonate; 3-(N,N-dimethyl-N-hexadecylammonio)-2-hydroxy-propane-1-sulfonate; 4-[N,N-di (2 (2-hydroxyethyl)-N(2-hydroxydodecyl) ammonio]-butane-1-carboxylate; 3-[S-ethyl-S-(3-dodecoxy-2-hydroxypropyl) sulfonio]-propane-1-phosphate; 3-[P,P-dimethyl-P-dodecylphosphonio]-propane-1-phosphonate; and S [N,N-di(3-hydroxypropyl)-N-hexadecylammonio]-2-hydroxy-pentane-1-sulfate. The alkyl groups contained in said detergent surfactants can be straight or branched and saturated or unsaturated.

The zwitterionic surfactant suitable for use in the present compositions includes a betaine of the general structure:

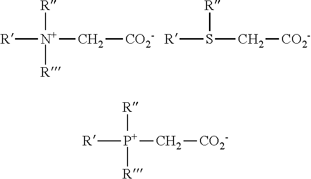

These surfactant betaines typically do not exhibit strong cationic or anionic characters at pH extremes nor do they show reduced water solubility in their isoelectric range. Unlike “external” quaternary ammonium salts, betaines are compatible with anionics. Examples of suitable betaines include coconut acylamidopropyldimethyl betaine; hexadecyl dimethyl betaine; C₁₂₋₁₄ acylamidopropylbetaine; C₈₋₁₄ acylamidohexyldiethyl betaine; 4-C₁₄₋₁₆ acylmethylamidodiethylammonio-1-carboxybutane; C₁₆₋₁₈ acylamidodimethylbetaine; C₁₂₋₁₆ acylamidopentanediethylbetaine; and C₁₂₋₁₆ acylmethylamidodimethylbetaine.

Sultaines useful in the present invention include those compounds having the formula (R(R¹)₂N⁺R²SO³⁻, in which R is a C₆-C₁₈ hydrocarbyl group, each R¹ is typically independently C₁-C₃ alkyl, e.g. methyl, and R² is a C₁-C₆ hydrocarbyl group, e.g. a C₁-C₃ alkylene or hydroxyalkylene group.

A typical listing of zwitterionic classes, and species of these surfactants, is given in U.S. Pat. No. 3,929,678 issued to Laughlin and Heuring on Dec. 30, 1975. Further examples are given in “Surface Active Agents and Detergents” (Vol. I and II by Schwartz, Perry and Berch). Each of these references is herein incorporated in their entirety.

In an embodiment, the compositions include from about 1 wt-% to about 20 wt-%, from about 2 wt-% to about 20 wt-%, or from about 2 wt-% to about 10 wt-% of the additional zwitterionic surfactant(s). In addition, without being limited according to the invention, all ranges recited are inclusive of the numbers defining the range and include each integer within the defined range.

### Additional Functional Ingredients

The components of the antimicrobial compositions can further be combined with various additional functional components. In some embodiments, the compositions including the at least one acid, alkyl ether carboxylic acid, water, and optional additional surfactant(s) make up a large amount, or even substantially all of the total weight of the composition. For example, in some embodiments few or no additional functional ingredients are included therein.

In other embodiments, additional functional ingredients may be included in the compositions. The functional ingredients provide desired properties and functionalities to the compositions. For the purpose of this application, the term “functional ingredient” includes a material that when dispersed or dissolved in a use and/or concentrate solution, such as an aqueous solution, provides a beneficial property in a particular use. Some particular examples of functional materials are discussed in more detail below, although the particular materials discussed are given by way of example only, and that a broad variety of other functional ingredients may be used.

In preferred embodiments, the compositions do not include quaternary ammonium compounds. In additional embodiments, the compositions do not include conventional Norovirus actives, including for example, ethanol, silver citrate, and/or electrolytic chlorine. In additional embodiments the compositions do not include alcohols and/or other organic solvents to beneficially provide a non-flammable product. In additional embodiments the compositions do not include fatty acid esters. In still further additional embodiments the compositions do not include hydrogen peroxide.

In other embodiments, the compositions may include defoaming agents, wetting agents, anti-redeposition agents, solubility modifiers, dispersants, rinse aids, metal protecting agents, stabilizing agents, corrosion inhibitors, sequestrants and/or chelating agents, threshold agent, additional surfactants, fatty acid esters, fragrances and/or dyes, rheology modifiers or thickeners, hydrotropes or couplers, buffers, solvents, sensor indicators, and the like.

### Fatty Acid Esters

The antimicrobial compositions can optionally include fatty acid esters. A fatty acid ester (FAE) is an ester resulting from the combination of a fatty acid with an alcohol. Examples of fatty acid esters can include sulfonated fatty acid esters, C6-C24 fatty acid ester ethoxylates, propoxylates or glycerides, or preferably C8-C12 fatty acid ester ethoxylates, propoxylates or glycerides. An example of a C6-C24, namely a C8-C10 fatty acid ester glycerides include octanoic/decanoic esters of glycerol. Still further examples of fatty acid esters can include glycerides (including monoglycerides, diglycerides, and triglycerides) when the alcohol is glycerol, sorbitan fatty acid esters (i.e. sorbitan sugar esters including for example sorbitan monooleate, sorbitan monooleatepolyoxyethylene ether), sorbitol fatty acid esters, polyethylene glycol fatty acid esters (e.g. tall oil fatty acids), polyglycerol fatty acid esters and the like.

Commercially available fatty acid esters include for example, Stepan GCC-Mild, Stepan 108, Tween 20, etc. For example, polyoxyethylene sorbitan fatty acid esters can be Tween 20, Tween 40, Tween 60 and Tween 80, while the sorbitan fatty acid esters can be Span 20, Span 40, Span 60 and Span 80.

If included in the compositions, the compositions include from about 1 wt-% to about 30 wt-% of the fatty acid esters, from about 1 wt-% to about 20 wt-% of the fatty acid esters, from about 5 wt-% to about 20 wt-% of the fatty acid esters, or from about 5 wt-% to about 15 wt-% of the fatty acid esters. In addition, without being limited according to the invention, all ranges recited are inclusive of the numbers defining the range and include each integer within the defined range.

In some embodiments the compositions do not include and are free of fatty acid esters.

### Defoaming Agents

Defoaming agents can optionally be included in the compositions. Generally, defoamers which can be used include alcohol alkoxylates and EO/PO block copolymers. Defoamers can also include polyalkylene glycol condensates and propyl glycols, including polypropyl glycol. In some embodiments, the compositions can include antifoaming agents or defoamers which are of food grade quality given the application of the methods. To this end, one of the more effective antifoaming agents includes silicones. Silicones such as dimethyl silicone, glycol polysiloxane, methylphenol polysiloxane, trialkyl or tetralkyl silanes, hydrophobic silica defoamers and mixtures thereof can all be used in defoaming applications.

Defoamers can be present at a concentration range from about 0.01 wt-% to 20 wt-%, 0.01 wt-% to 20 wt-%, from about 0.01 wt-% to 5 wt-%, or from about 0.01 wt-% to about 1 wt-%.

### Methods of Use

The antimicrobial compositions are particularly well suited for treating surfaces in need of antimicrobial efficacy against a broad spectrum of microorganisms, including yeasticidal efficacy. In further aspects, the antimicrobial compositions with yeasticidal activity are still further well suited for treating surfaces in need of virucidal efficacy against small, non-enveloped viruses, large, non-enveloped viruses and/or any enveloped viruses without the use of any quaternary ammonium compounds and/or sulfonated anionic surfactants having regulatory limitations.

The methods of use for antimicrobial, including yeasticidal and antiviral, disinfection, include a contacting step, wherein the composition is applied to a surface in need of treatment. In an aspect, contacting the composition is to a surface contaminated with a microorganism, including any one of bacteria, virus and/or yeast/fungus. The contaminated surfaces can be precleaned and/or soiled.

In a preferred aspect, the methods of use provide complete kill of yeast. Beneficially, in an aspect, greater than a 99.9% reduction (3-log order reduction) in such population, or greater than 99.99% reduction (4-log order reduction) in such populations on a surface is achieved with a contact time of less than about 60 minutes, less than about 30 minutes, less than about 15 minutes, or less than about 5 minutes.

In a preferred aspect, the methods of use provide complete kill of a Norovirus. Beneficially, in an aspect, greater than a 99.9% reduction (3-log order reduction) in such population, greater than 99.99% reduction (4-log order reduction) in such populations, or greater than a 99.999% reduction (5-log order reduction) in the population of a Norovirus on a surface is achieved with a contact time of less than about 60 minutes, less than about 30 minutes, less than about 15 minutes, less than about 5 minutes, less than about 1 minute, less than about 30 seconds, or even less than about 15 seconds.

In a further aspect, contacting the antimicrobial compositions can be to a food contact and/or non-food contact hard surface. Such surfaces can further include instruments, such as medical instruments. Surfaces can also include those cleaned in third-sink sanitizing, including various wares. In still further aspects, contacting the composition can be to a CIP (clean in place) application.

In still further aspects, contacting the antimicrobial compositions can be to a ware wash machine, such as a ware wash application.

In still further aspects, contacting the antimicrobial compositions can be to a third sink sanitizing application or first sink disinfecting detergent application. In a still further aspect, the contacting is beneficially compatible with first sink detergents, such that a third sink sanitizing step could be used as a water recycle to combine with a first sink detergent. This is a benefit over conventional compositions containing quaternary ammonium compounds which are not compatible with first sink detergents.

In still further aspects, contacting the antimicrobial compositions can be to a tissue surface, including tissue treatment applications. Exemplary tissue surfaces include mammalian skin, such as animal or human skin, including for example human hands.

The various surfaces to which the antimicrobial compositions can be applied can include any conventional application means. Application can include, for example, by wiping, spraying, dipping, immersing, or the like. The contacting can also include providing a use solution of the concentrate liquid for the contacting. The contacting step allows the composition to contact the soiled surface for a predetermined amount of time. The amount of time can be sufficient to allow, including from a few seconds to an hour, from about 15 seconds, or about 30 seconds to about 60 minutes, or any range therebetween. In a preferred embodiment, the contact time required for antimicrobial and yeasticidal efficacy is less than about 30 minutes, less than about 15 minutes, less than about 10 minutes, less than about 5 minutes, or less than about 1 minute. In still further embodiments, the contact time required for antimicrobial and yeasticidal efficacy is less than about 30 seconds, or even less than about 15 seconds.

The methods may comprise a single step of applying the antimicrobial compositions onto the surface without direct physical removal, such as a rinse step and/or a wiping step. Beneficially, in various embodiments the compositions can optionally provide a no-rinse application. As a further benefit, in various embodiments the antimicrobial compositions can optionally provide a wiping application. As a still further benefit, in various embodiments the antimicrobial compositions can provide a no-rinse and no wiping application.

In some aspects, the methods can further include a precleaning step, such as where a cleaning compositions is applied, wiped and/or rinsed, and thereafter followed by the applying of the antimicrobial compositions. The compositions and methods of use thereof can include treating cleaned or soiled surfaces. In some embodiments the amount of contact time between the composition and the surface is sufficient to reduce the population of microorganisms (including yeast, bacteria and/or viral pathogens) on a surface to provide greater than a 99.9% reduction (3-log order reduction) in such population, greater than 99.99% reduction (4-log order reduction) in such populations, or greater than a 99.999% reduction (5-log order reduction) in the population of microorganisms and pathogens. The contact time is preferably less than about 30 minutes, less than about 15 minutes or less than about 5 minutes.

Temperature conditions for the methods can range from about 40° F.-160° F., about 60° F.-140° F., or about 70° F.-140° F.

Beneficially, the methods do not require a rinse step. In an aspect, the antimicrobial compositions are food contact approved and do not require a rinse step. As a further benefit, the methods do not cause corrosion and/or interfere with surfaces (e.g. hazy, dull or other negative aesthetic effects on the surface).

The methods can optionally include the use of various sensors and/or indicators. In an aspect, the level of active ingredients in use solution can be monitored by various ways. In one approach, the critical pH of the solution at which the product will start to lose its biocidal efficacy significantly is visually indicated by a color change, and the color change is achieved by choosing a dye that show dramatic color change at this pH. The dye could be simply incorporated into the product, and preferably the dye is incorporated into a polymeric substrate to form a color change strip, and the strip will put in the container, for example the third sink to show the color change when the solution pass the critical pH value.

Additionally, the level of anionic surfactants in use solution could also be monitored by a similar manner, where a color change will indicate the critical concentration of anionic surfactant needed for biocidal efficacy.

In an additional embodiment, as an alternative to visual indicators, properties of the use solution including pH, anionic activity, fluorescence, and/or conductivity can be monitored by sensors that provide a visual or audible signal when the solution is no longer within a specified range. In some embodiments, a marker molecule can be added to the composition, where the change of the active ingredients in the use solution will trigger the physical and/or chemical property changes of the marker molecule, and the change is quantified through a signal processing.

In embodiments, the antimicrobial compositions meet bactericidal requirements for EN1276 (bacterial suspension study), EN13697 (bacteria-carrier based study), and EN1650 (bacterial suspension study) at 18° C.-25° C. under clean and/or dirty conditions. In embodiments, the antimicrobial compositions meet virucidal requirements for EN14476 at 18° C.-25° C. under clean and/or dirty conditions. As one skilled in the art will appreciate, the suspension studies can also be referred to as Phase 2, Step 1 (or 2.1-suspension) studies and the carrier studies can also be referred to as Phase 2, Step 2 (or 2.2-carrier) studies or also laboratory simulated surface tests.

### EMBODIMENTS

The present disclosure is further defined by the following numbered embodiments:
1. An antimicrobial composition with yeasticidal and virucidal efficacy comprising: at least one acid providing a use pH of the composition≤ about 5; a C6-C11 alkyl ether carboxylic acid with a degree of ethoxylation≤6; and optionally an additional surfactant.
2. The composition of embodiment 1, wherein the acid comprises a strong acid comprising methane sulfonic acid and/or a weak acid comprising a hydroxycarboxylic acid.
3. The composition of any one of embodiments 1-2, wherein the C6-C11 alkyl ether carboxylic acid has the formula R—(CH₂CH₂O)ₙ—CH₂COOH, where R is C6-C11 alkyl group, and n is from 1-6.
4. The composition of embodiments 3, wherein R is C6-C10 alkyl group.
5. The composition of any one of embodiments 1-4, wherein the additional surfactant comprises an alpha olefin sulfonate, alkane sulfonate, alkyl sulfonate, sulfonated carboxylic acid ester, alkyl polyglucoside, phosphate ester or combination thereof.
6. The composition of embodiments 5, wherein the additional surfactant comprises a C8-C22 alpha olefin sulfonate.
7. The composition of embodiments 5, wherein the additional surfactant comprises a C8-C16 alpha olefin sulfonate.
8. The composition of any one of embodiments 1-4, wherein the acid(s) comprise from about 10 wt-% to about 50 wt-% of the composition, the alkyl ether carboxylic acid comprises from about 5 wt-% to about 40 wt-%, and the additional anionic surfactant comprises from about 0.1 wt-% to about 20 wt-%.
9. The composition of any one of embodiments 1-8, wherein the composition is a liquid concentrate.
10. The composition of any one of embodiments 1-9, wherein the composition does not include fatty acid esters.
11. The composition of any one of embodiments 1-10, wherein the composition does not contain hydrogen peroxide.
12. A method of using an antimicrobial composition with yeasticidal efficacy, comprising: contacting the antimicrobial composition of any one of embodiments 1-11 to a surface in need of treatment, and providing at least a 3 log reduction, or at least a 4 log reduction in a yeast population within less than about 5 minutes.
13. A method of using an antimicrobial composition with yeasticidal efficacy, comprising: contacting the antimicrobial composition of any one of embodiments 1-11 to a surface in need of treatment, wherein the composition passes one or more of the following European standards at a contact time of less than or equal to about 5 minutes: EN13697, EN1650, EN1276, EN13697, and EN14476.
14. The method of any one of embodiments 12-13, wherein the composition is diluted to a use solution before the contacting step.
15. The method of embodiment 14, wherein the diluted use solution is made from about a 0.5% to about a 3% by weight dilution.
16. The method of any one of embodiments 12-15, wherein the contacting is by wiping, dipping, immersing, or spraying.
17. The method of any one of embodiments 12-16, wherein the composition and/or use solution do not exhibit unpleasant odors.
18. The method of any one of embodiments 12-17, wherein the surface is a hard surface.
19. The method of embodiment 18, wherein the hard surface is a precleaned hard surface, a surface contaminated with bacteria, virus and/or yeast populations, and/or a human or mammalian tissue.
20. The method of any one of embodiments 12-19, wherein the contacting step is at an aqueous use temperature from about 40° F.-160° F.
21. The method of any one of embodiments 12-20, wherein the composition meets the requirements of EN1276 at 18° C.-25° C. under clean and/or dirty conditions.
22. The method of any one of embodiments 12-20, wherein the composition meets the requirements of EN13697 and/or EN1650 at 18° C.-25° C. under clean and/or dirty conditions.
23. The method of any one of embodiments 12-20, wherein the composition meets the requirements of EN14476 at 18° C.-25° C. under clean and/or dirty conditions.
24. The method of any one of embodiments 12-23, wherein the method does not require a rinse step.

### EXAMPLES

Embodiments of the present disclosure are further defined in the following non-limiting Examples. It should be understood that these Examples, while indicating certain embodiments of the disclosure, are given by way of illustration only. From the above discussion and these Examples, one skilled in the art can ascertain the essential characteristics of this disclosure, and without departing from the spirit and scope thereof, can make various changes and modifications of the embodiments of the disclosure to adapt it to various usages and conditions. Thus, various modifications of the embodiments of the disclosure, in addition to those shown and described herein, will be apparent to those skilled in the art from the foregoing description. Such modifications are also intended to fall within the scope of the appended claims.

The following materials were utilized in the Examples as summarized:

Alkyl ether carboxylic acids and mixtures thereof, anionic AEC surfactants, available from multiple sources including for example, Clariant, Colonial Chemical, Innospec, Pilot Chemical, and Kao which sold under the tradename AKYPOR.

### Edta

AOS (40%), Alpha Olefin Sulfonate, anionic surfactant, available from multiple sources.

MSA (70%), strong acidulent, available from multiple sources.

Glycolic acid (70%), acidulent and solvent, available from multiple sources.

DI water, deionized water.

The following alkyl ether carboxylic acids were evaluated in the Examples as shown in Table 2.

TABLE 2

| Compound | Alkyl | Number of EO (avg.) |
|---|---|---|
| Capryleth-4 Carboxylic acid | C8 | 4 |
| Capryleth-6 Carboxylic acid | C8 | 5 |
| Capryleth-9 Carboxylic acid | C8 | 9 |
| Capryl/Capric Ethoxylate | C8/C10 | 1 |
| Carboxylic acid | | |
| Hapteth-3 Carboxylic acid | C5 | 3 |
| Laureth-4 Carboxylic acid | C12 | 2.5 |
| Laureth-6 Carboxylic acid | C12 | 4.5 |

For the testing EN hard water was prepared according to the following methodology: Solution A was prepared by dissolving 1.98 g magnesium chloride (MgCl₂) and 4.62 g calcium chloride (CaCl₂)) in lab purified water and diluting to 100 mL. The solution was sterilized by membrane filtration. Solution B was prepared by dissolving 3.50 g sodium bicarbonate (NaHCO₃) in lab purified water and diluting to 100 mL. The solution was sterilized by membrane filtration. Both solutions were stored in the refrigerator (2-8° C.) and used before expiration date for each solution (one month for solution A and one week for solution B). On the date of preparation, 6.0 mL of solution A and 8.0 mL of solution B were added to approximately 700 mL of sterile lab purified water in a 1000 mL volumetric flask. Sterile lab purified water was added to 1000 mL volume. The hard water was well mixed. The pH of the hard water was adjusted with 1 N hydrochloric acid to a target pH range of 7.0±0.2. The water hardness was verified by adding 10 mL of hard water to 40 mL of lab purified water. A small amount of water hardness indicator and 1 mL of water hardness buffer were added and mixed well. The solution was then titrated for ppm as CaCO₃ with 0.01M EDTA.

Various European norms for disinfection testing are utilized in the following examples to demonstrate the disinfectant efficacy of the antimicrobial products. Such European standards allow for a minimum disinfectant requirement to be established. For example EN1276 is an efficacy test identifying the minimum requirements for bactericidal efficacy of chemical disinfectants that form a homogeneous, physically stable preparation when diluted with hard water or, in the case of ready-to-use products, with water. EN1276 applies to disinfectant products that are used in food, industrial, domestic and institutional areas excluding areas and situations where disinfection is medically indicated and excludes products used on living tissues except those for hand hygiene in the aforementioned areas. EN1650 provides an efficacy test and the minimum requirements for fungicidal or yeasticidal efficacy of chemical disinfectant products that form a homogeneous, physically stable preparation when diluted with hard water or, in the case of ready-to-use-products, with water. EN1650 applies to products that are used in food, industrial, domestic and institutional areas excluding areas and situations where disinfection is medically indicated and excluding products used on living tissues except those for hand hygiene in the above considered areas. Both EN1276 and EN1650 are consider phase 2/step 1 tests, which involve quantitative suspension testing. These are two examples of regulatory standards used to evaluate the compositions described herein.

### Example 1

Bactericidal Efficacy Screening. Bactericidal efficacy screening was conducted with the formulations of Table 3 following EN1650 for C. albicans (ATCC 10231) at a 5 minute contact time. The test formulations were prepared by adding materials to a glass beaker and stirred with a stir bar until homogeneous.

TABLE 3

| | Formulation A | Formulation B | Formulation C | Formulation D | Formulation E | Formulation F | Formulation G |
|---|---|---|---|---|---|---|---|
| Component | wt. % | wt. % | wt. % | wt. % | wt. % | wt. % | wt. % |
| Capryleth-6 | 30.0 | 0.0 | 0.0 | 0.0 | 0.0 | 0.0 | 0.0 |
| carboxylic | | | | | | | |
| acid | | | | | | | |
| Capryleth-9 | 0.0 | 30.0 | 0.0 | 0.0 | 0.0 | 0.0 | 0.0 |
| carboxylic | | | | | | | |
| acid | | | | | | | |
| Capryleth-4 | 0.0 | 0.0 | 30.0 | 0.0 | 0.0 | 0.0 | 0.0 |
| Carboxylic | | | | | | | |
| acid | | | | | | | |
| Hapteth-3 | 0.0 | 0.0 | 0.0 | 30.0 | 0.0 | 0.0 | 0.0 |
| Carboxylic | | | | | | | |
| acid | | | | | | | |
| Capryl/Capric | 0.0 | 0.0 | 0.0 | 0.0 | 30.0 | 0.0 | 0.0 |
| Ethoxylate | | | | | | | |
| Carboxylic | | | | | | | |
| acid | | | | | | | |
| Laureth-4 | 0.0 | 0.0 | 0.0 | 0.0 | 30.0 | 30.0 | 0.0 |
| carboxylic | | | | | | | |
| acid | | | | | | | |
| Laureth-6 | 0.0 | 0.0 | 0.0 | 0.0 | 0.0 | 0.0 | 30.0 |
| carboxylic | | | | | | | |
| acid | | | | | | | |
| MSA (70%) | 10-15 | [symbol] 0-15 | 10-15 | 10-15 | 10-15 | 10-15 | 10-15 |
| Alkyl olefin | 2-6 | 2-6 | 2-6 | 2-6 | 2-6 | [symbol] -6 | [symbol] -6 |
| sulfonate | | | | | | | |
| (40%) | | | | | | | |
| Glycolic acid | 10-30 | [symbol] 0-30 | 10-30 | 10-30 | [symbol] 0-30 | [symbol] -30 | [symbol] 0-30 |
| (70%) | | | | | | | |
| DI water | 20-40 | [symbol] 0-40 | 20-40 | 20-40 | [symbol] 0-40 | 20-40 | 20-40 |
| Total | 100.0 | 100.0 | 100.0 | 100.0 | 100.0 | 100.0 | 100.0 |

[symbol]

indicates data missing or illegible when filed

On the test date, 1% by weight dilution of the product (which considers dilution that takes place within the micro efficacy method) according to the tables below with EN hard water as the diluent were made. The testing was conducted under dirty conditions (3.0 g/L bovine albumin) at 20° C. with a 5 minute contact time using EN hard water. The results are shown in Table 4.

TABLE 4

| | | | EN 1650 - |
|---|---|---|---|
| | | Interfering | Log reduction |
| Test Substance | Contact time | Substance | of C. albicans |
| 1% Formula A | 5 minutes | Dirty Conditions | 3.39 |
| 1% Formula B | 5 minutes | Dirty Conditions | 0.82 |
| 1% Formula C | 5 minutes | Dirty Conditions | >4.23 |
| 1% Formula D | 5 minutes | Dirty Conditions | <0.86 |
| 1% Formula E | 5 minutes | Dirty Conditions | 2.23 |
| 1% Formula F | 5 minutes | Dirty Conditions | <0.86 |
| 1% Formula G | 5 minutes | Dirty Conditions | <0.86 |

The EN 1650 testing requires a ≥4 log reduction against C. albicans. As shown in the Table, Formula C passes EN 1650 with >4 log reduction against C. albicans. In addition Formula A approaches a passing log reduction with a 3.39 log reduction, indicating the capryleth-6 carboxylic acid as the anionic AEC surfactant provides benefit. The Formulations were tested at a use solution pH. The anionic AEC surfactants in Formulation A and C provide clear benefit, and Formulation C could surpass the 4 log reduction with a lowered pH and/or increased surfactant concentration to provide the 4+ log reduction required for EN 1650.

### Example 2

Additional efficacy screening for EN1276 using S. aureus (ATCC 6538), E. hirae (ATCC 10541), E. coli (ATCC 10536), and P. aeruginosa (ATCC 15442) were completed for the composition in Table 5 at a 5 minute contact under dirty conditions (3.0 g/L bovine albumin).

TABLE 5

| | Formulation H |
|---|---|
| Component | wt. % |
| Capryleth-6 carboxylic acid | 25.0 |
| MSA (70%) | 10-15 |
| Alkyl olefin sulfonate (40%) | 2-6 |
| Glycolic acid (70%) | 10-30 |
| DI water | 20-40 |
| Total | 100.0 |

TABLE 6

| | Test | | Result (Log |
|---|---|---|---|
| Test Substance | Method | Test Organism | Reduction) |
| 1% Formula H | EN 1650 | C. albicans | 4.26 |
| 1% Formula H | EN 1276 | E. hirae | >5.38 |
| 1% Formula H | EN 1276 | S. aureus | >5.40 |
| 1% Formula H | EN 1276 | P. aeruginosa | >5.38 |
| 1% Formula H | EN 1276 | E. coli | >5.25 |
| 1% Formula H | EN 13697 | C. albicans | >3.74 |
| 1% Formula H | EN 13697 | E. hirae | >4.29 |
| 1% Formula H | EN 14776 | Vaccina virus | 4.67 |
| 1% Formula H | EN 16777 | Vaccina virus | 4.09 |

The screening of the Formula H (including lower concentration of the surfactant Capryleth-6 carboxylic acid) achieved the EN 1650 suspension test for yeast C. albicans by exceeding a 4-log reduction. In addition the Formula H provided a ≥5 log reduction against S. aureus, E. hirae, E. coli, and P. aeruginosa in the suspension test EN 1276. As shown in Table 6, the Formula H also achieved the surface testing EN13697 for yeast C. albicans by exceeding a 3-log reduction and surface testing EN 13697 for E. hirae (the most challenging species) by exceeding a 4 log reduction. EN 14776 and EN16777 for anti-viral efficacy were both passed by Formula H achieving a 4-log reduction. These results confirm the unique role the C6-C11 alkyl ether carboxylic acids with a degree of ethoxylation≤6 for efficacy against bacteria, yeast, and viruses.

### Example 3

Additional testing to confirm food contact sanitizing efficacy (AOAC Method 960.09) comparing three AEC surfactants was conducted where the surfactants were diluted in 500 ppm synthetic hard water and pH adjusted to 2.1 with phosphoric acid. The evaluated AEC surfactants are further described above in Table 2. The results are summarized in Table 7.

TABLE 7

| | | | Log reduction | |
|---|---|---|---|---|
| Test Substance | pH | Exposure time | S. aureus | E. coli |
| 500 ppm Capryleth-4 | 2.06 | 30 seconds | >7.34 | >7.59 |
| carboxylic acid | | | | |
| 750 ppm Capryleth-4 | 2.04 | 30 seconds | >7.34 | >7.59 |
| carboxylic acid | | | | |
| 1000 ppm Capryleth-4 | 2.04 | 30 seconds | >7.34 | >7.59 |
| carboxylic acid | | | | |
| 500 ppm Capryleth-6 | 2.06 | 30 seconds | >7.34 | 1.98 |
| Carboxylic acid | | | | |
| 750 ppm Capryleth-6 | 2.05 | 30 seconds | >7.34 | 3.44 |
| Carboxylic acid | | | | |
| 1000 ppm Capryleth-6 | 2.04 | 30 seconds | >7.34 | >7.59 |
| Carboxylic acid | | | | |
| 500 ppm Capryleth-9 | 2.07 | 30 seconds | 5.31 | <1.19 |
| Carboxylic acid | | | | |
| 750 ppm Capryleth-9 | 2.05 | 30 seconds | >7.34 | <1.19 |
| Carboxylic acid | | | | |
| 1000 ppm Capryleth-9 | 2.04 | 30 seconds | >7.34 | <1.19 |
| Carboxylic acid | | | | |

The alkyl ether carboxylic acid (AEC) surfactants achieve the required ≥5 log reduction of S. aureus for food contact sanitizing efficacy at concentrations as low as 500 ppm. Differentiation between the AEC surfactants is observed with efficacy against E. coli, where the lower EO surfactants required significantly lower concentrations of surfactant to achieve a ≥5 log reduction. The testing of the AEC surfactants with acid as sanitizing compositions demonstrate that each of the C8 alkyl ether carboxylic acids with a degree of ethoxylate≤6 (both Capryleth-4 Carboxylic acid and Capryleth-6 Carboxylic acid) provide improved efficacy against S. aureus and E. coli at all evaluated concentrations, with passing E. coli log reductions for the lower EO surfactant at all evaluated concentrations.

It is to be understood that while the invention has been described in conjunction with the detailed description thereof, the foregoing description is intended to illustrate, and not limit the scope of the invention, which is defined by the scope of the appended claims. Other embodiments, advantages, and modifications are within the scope of the following claims. Any reference to accompanying drawings which form a part hereof, are shown, by way of illustration only. It is understood that other embodiments may be utilized and structural changes may be made without departing from the scope of the present disclosure. All publications discussed and/or referenced herein are incorporated herein in their entirety.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

All publications and patent applications in this specification are indicative of the level of ordinary skill in the art to which this invention pertains. All publications and patent applications are herein incorporated by reference to the same extent as if each individual publication or patent application were specifically and individually indicated as incorporated by reference.

What is claimed is:

1. An antimicrobial composition with yeasticidal and virucidal efficacy comprising:
at least one acid comprising a hydroxycarboxylic acid and/or alkyl carboxylic acid providing a use pH of the composition≤about 5;
an alkyl ether carboxylic acid having the formula R—(CH₂CH₂O)ₙ—CH₂COOH,
wherein R is a C6-C11 alkyl group, and n is from 1-6 to provide; and optionally an additional surfactant.

2. The composition of claim 1, wherein the hydroxycarboxylic acid comprises glycolic acid, citric acid, tartaric acid, malic acid, or gluconic acid and/or the alkyl carboxylic acid comprises formic acid or acetic acid.

3. The composition of claim 1, wherein the acid further comprises a strong acid comprising methane sulfonic acid and/or an additional weak acid.

4. The composition of claim 1, wherein R is C6-C10 alkyl group.

5. The composition of claim 1, wherein the additional surfactant comprises an alpha olefin sulfonate, alkane sulfonate, alkyl sulfonate, sulfonated carboxylic acid ester, alkyl polyglucoside, phosphate ester or combination thereof.

6. The composition of claim 4, wherein the additional surfactant comprises a C8-C22 alpha olefin sulfonate or a C8-C16 alpha olefin sulfonate.

7. The composition of claim 1, wherein the acid(s) comprise from about 10 wt-% to about 50 wt-% of the composition, the alkyl ether carboxylic acid comprises from about 5 wt-% to about 40 wt-% of the composition, and the optional surfactant comprises an anionic surfactant that comprises from about 0.1 wt-% to about 20 wt-% of the composition.

8. The composition of claim 1, wherein the composition is a liquid concentrate.

9. The composition of claim 1, wherein the composition does not include fatty acid esters and/or hydrogen peroxide.

10. A method of using an antimicrobial composition with yeasticidal efficacy, comprising:
contacting the antimicrobial composition of claim 1 to a surface in need of treatment, and providing at least a 3 log reduction in a yeast population within less than about 5 minutes.

11. The method of claim 10, wherein the composition is diluted to a use solution before the contacting step.

12. The method of claim 11, wherein the diluted use solution is made from about a 0.5% to about a 3% by weight dilution.

13. The method of claim 10, wherein the contacting is by wiping, dipping, immersing, or spraying.

14. The method of claim 10, wherein the composition and/or use solution do not exhibit unpleasant odors.

15. The method of claim 10, wherein the surface is a hard surface.

16. The method of claim 15, wherein the hard surface is a precleaned hard surface.

17. The method of claim 15, wherein the hard surface is a surface contaminated with bacteria, virus and/or yeast populations.

18. The method of claim 10, wherein the surface is a human or mammalian tissue.

19. The method of claim 10, wherein the contacting step is at an aqueous use temperature from about 40° F.-160° F., and/or wherein the composition provides at least 3 log reduction, 4 log reduction, or 5 log reduction for virucidal activity at 18° C.-25° C. under clean and/or dirty conditions in suspension or on a hard surface.

20. The method of claim 10, wherein the method does not require a rinse step.
